(19) United States
(12) Patent Application Publication
(10) Pub. No.: US 2006/0131815 A1
(43) Pub. Date: Jun. 22, 2006

(54) Honeycomb seal

(76) Inventor: Reinhold Meier, Dorfen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/537,504

(22) PCT Filed: Nov. 21, 2003
(86) PCT No.: PCT/DE03/03856

§ 371 Date: Nov. 30, 2005

(30) Foreign Application Priority Data
Dec. 2, 2002 (DE) 10259963.7

(51) Int. Cl. F16J 15/447

(52) U.S. Cl. 277/414

(57) ABSTRACT

A honeycomb seal which is manufactured by powder metallurgical injection molding is disclosed. The honeycomb seal is composed preferably of several segments. Each segment is embodied as a single piece and has a base element as well as honeycomb elements that are embodied as a single piece with the base element.

### BACKGROUND AND SUMMARY OF THE INVENTION

This application claims the priority of International Application No. PCT/DE03/03856, filed Nov. 21, 2003, and German Patent Document No. 102 59 963.7, filed Dec. 20, 2002, the disclosures of which are expressly incorporated by reference herein.

The present invention relates to a honeycomb seal, which is preferably used as a seal between a stationary component and a moving component, in particular between a rotor and stator of a gas turbine.

Gas turbines, which are used as engines in airplanes for example, as a rule include several stationary guide blades as well as several rotating moving blades. A stationary housing surrounds the guide blades and the moving blades. The rotating moving blades rotate relative to the stationary housing, wherein a radial gap is formed between the blade tips of the rotating moving blades and the housing. There is also a comparable gap between the radial inside ends of the guide blades and the rotor bearing the moving blades. This radial gap should be kept as small as possible in order to optimize the efficiency of the gas turbine. Hence it follows from this that even though the radial gap is required on the one hand to guarantee the rotatability of the moving blades vis-à-vis the housing, on the other hand, the radial gap is disadvantageous for efficiency reasons.

As a result, honeycomb seals are used in gas turbines. The honeycomb seals seal the radial gap between the rotating moving blades and the stationary housing, on the one hand, and, on the other hand, facilitate the rotatability of the moving blades vis-à-vis the housing without the blade tips of the moving blades being damaged during rotation. These honeycomb seals are used in the same way in the gap between the guide blades and the rotor. Moving blades can run directly against these types of honeycomb seals with their blade tips or with the so-called sealing fins on their blade cover bands.

Prior art honeycomb seals are made of a basic body and honeycomb elements, wherein the honeycomb elements and the basic body are separate components, which are connected to each other via high-temperature soldering in a vacuum. The honeycomb elements are ground to size and then deburred. The shape and size of the honeycomb elements is the same for the most part. The design freedom of the honeycomb seal is limited.

Starting from this, the present invention is based on the objective of creating a novel honeycomb seal in which greater design freedom is possible, and which is simpler to manufacture in terms of the manufacturing process.

According to the invention, the honeycomb seal is manufactured by powder metallurgical injection molding. Powder metallurgical injection molding is also designated as metal injection molding (MIM). The present invention proposes for the first time that a honeycomb seal be manufactured by powder metallurgical injection molding. This results in greater design freedom for the honeycomb seal. In addition, the manufacturing costs are lower. The grinding and deburring processing steps are eliminated. In addition, a weight reduction is produced for the honeycomb seal in accordance with the invention.

According to another aspect of the present invention, the honeycomb seal has a base element and honeycomb elements that are embodied as a single piece with the base element. The honeycomb seal is preferably composed of several segments with honeycomb elements, wherein each segment has a base element and honeycomb elements that are embodied as a single piece with the base element. As a result of this, it is possible to provide the honeycomb seal with different properties in sections, e.g., with different geometries or material properties, in order to thereby adapt the honeycomb seal in sections or in segments to the desired properties.

The honeycomb elements and the base element can be composed of different materials, wherein the honeycomb elements, e.g., should be easy to abrade and the base elements should possess high temperature resistance.

### BRIEF DESCRIPTION OF THE DRAWINGS

Without being limited to these, exemplary embodiments of the invention are explained on the basis of the drawings. The drawings show the following:

FIG. 1 is a schematic, perspective side view of a honeycomb seal in accordance with the invention as defined by a first exemplary embodiment of the invention.

FIG. 2 is a schematic, perspective side view of a honeycomb seal in accordance with the invention as defined by a second exemplary embodiment of the invention.

FIG. 3 is a schematic, perspective side view of a honeycomb seal in accordance with the invention as defined by a third exemplary embodiment of the invention.

### DETAILED DESCRIPTION OF THE DRAWINGS

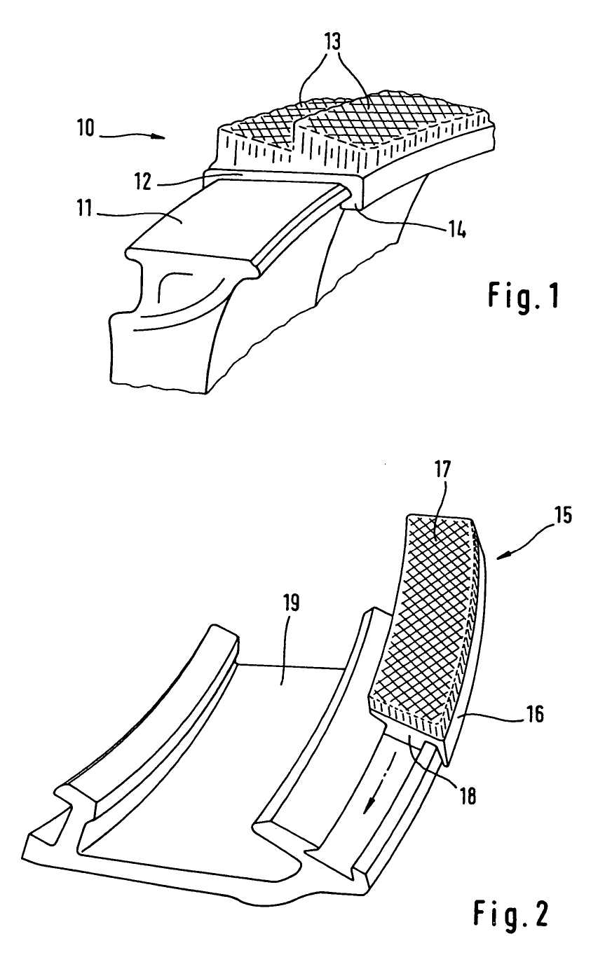

FIGS. 1 through 3 show different embodiments of honeycomb seals in accordance with the invention. The honeycomb seals shown there are preferably used to seal a gap between rotating moving blades and a stationary housing of a gas turbine. Alternatively, the honeycomb seals are used for sealing between guide blades and the rotor of a gas turbine. Thus, these types of honeycomb seals assume the task of sealing a radial gap between blade tips or sealing fins on cover bands of the rotating moving blades and the stationary housing in gas turbines that are used as aircraft engines for example. In order to achieve optimal efficiency of the gas turbine, the gap between the blade tips or sealing fins on the cover bands of the moving blades and the housing should be embodied to be as small as possible. However, so that the blade tips of the moving blades are not damaged during the rotation of the moving blades, the honeycomb seal must seal not only the radial gap, but also protect the blade tips or sealing fins from damage.

FIG. 1 shows a honeycomb seal 10 in accordance with a first exemplary embodiment of the invention. The honeycomb seal 10 shown is slid onto a supporting structure 11. The honeycomb seal 10 has a base element 12, wherein the base element 12 bears honeycomb elements 13. The base element 12 and the honeycomb elements 13 are embodied as a single piece. According to the invention, the honeycomb seal 10 is manufactured by powder metallurgical injection molding. Powder metallurgical injection molding is also designated as metal injection molding. Details about this manufacturing method are known from the relevant literature.

At this point it should be noted with respect to powder metallurgical injection molding that products manufactured with the aid of this manufacturing process are distinguished by geometric design freedom. In the case of powder metallurgical injection molding, a metal powder is mixed with a binding agent to form a homogenous mass. The volume percent of the metal powder in this case is preferably greater than 50%. Injection molding is used to process this homogenous mass of binding agent and metal powder. In this connection, molded bodies are manufactured. In the case of the present invention, the molded bodies correspond to the honeycomb seal in accordance with the invention. These molded bodies already feature all typical features of the desired honeycomb seal. However, they have a volume that is increased by the content of the binding agent. Subsequently, the molded parts are subjected to a releasing process. Depending upon the binding agent used, it is either thermally disintegrated, vaporized or extracted via a solvent. The remaining porous molded bodies are then compressed via sintering using various inert gases or a vacuum to form the components with the final geometrical properties. The finished component is available once this is complete.

Consequently, it is within the meaning of the present invention to manufacture the honeycomb seal 10, which is composed of a base element 12 and of honeycomb elements 13 connected as a single piece with the base element, using powder metallurgical injection molding.

The base element 12 of honeycomb seal 10 in FIG. 1 has lateral guide sections 14, which can be used to slide the honeycomb seal 10 on the supporting structure 11. Consequently, the contour of the guide elements 14 is adapted to the contour of the supporting structure 11 onto which the honeycomb seal 10 is supposed to be slid.

FIG. 2 shows a second honeycomb seal 15 in accordance with the invention. The honeycomb seal 15 in FIG. 2 also has a base element 16 and honeycomb elements 17 that are connected as a single piece with the base element 16. Present again in the area of the base element 16 is a guide element 18, which can be used to slide the honeycomb seal 15 into a supporting structure 19. The honeycomb seal 15 of the exemplary embodiment in FIG. 2 is also manufactured using powder metallurgical injection molding.

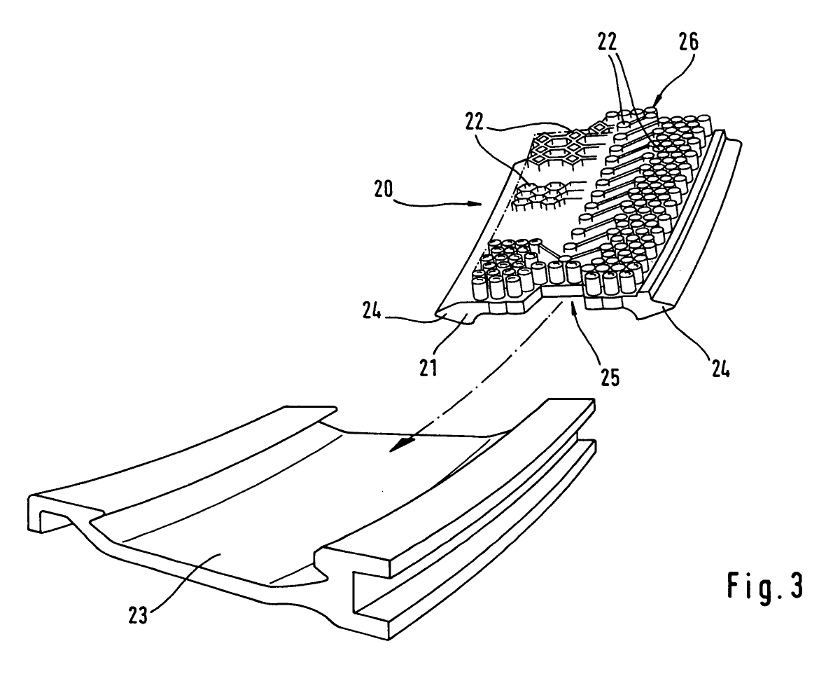

Already at this point reference should be made to the fact that the honeycomb seals 10 or 15 of the exemplary embodiments in FIGS. 1 and 2 are preferably composed of several segments. Thus, several segments within the meaning of the exemplary embodiments in FIGS. 1 and 2 can be slid onto the corresponding supporting structure. All segments then in turn have a base element 12 or 16 and honeycomb elements 13 or 17 that are embodied as a single piece with the base element. As FIG. 3 shows, the segments have slots for circumferential sealing purposes and tongues on the opposing end of the segment. These tongues engage in the slots of the respective adjacent segments. The slots and the tongues are manufactured as integral elements during the MIM process.

FIG. 3 shows another exemplary embodiment of a honeycomb seal 20 in accordance with the invention. The honeycomb seal 20 shown there also has a base element 21 as well as honeycomb elements 22 embodied as a single piece with the base element 21. FIG. 3 shows that the honeycomb elements 22 have different geometric shapes, whereby different areas are possible, in particular, in the axial direction.

The edges of the base element 21 serve as guide elements in order to slide the honeycomb seal 20 into a supporting structure 23. In the exemplary embodiment depicted in FIG. 3, the edge areas of the base element 21 accordingly form wedge-shaped guide elements 24, which engage in corresponding recesses in the supporting part 23 or are slid into the supporting part.

The honeycomb seal 20 in the exemplary embodiment in FIG. 3 is also preferably composed of several segments. As FIG. 3 also shows, the segment of the honeycomb seal 20 that is depicted in FIG. 3 has a recess 25 on one end and a projection 26 on an opposing end. If several segments within the sense of FIG. 3 are positioned in the supporting structure 23, then the segments interlock with each other to avoid axial relative displacements. In this case, then a projection 26 of a segment of the honeycomb seal 20 engages in a corresponding recess 25 of an adjacent segment. The segments of the honeycomb seal in the exemplary embodiment in FIG. 3 are also manufactured using powder metallurgical injection molding.

The honeycomb seals 10, 15 and 20 of the exemplary embodiments according to FIGS. 1 through 3 possess a great degree of design freedom. Thus, honeycomb seals whose honeycomb elements can be individually adapted in terms of their geometrical design can be manufactured with the aid of powder metallurgical injection molding. Using powder metallurgical injection molding to manufacture the honeycomb seal in accordance with the invention reduces manufacturing expenditures. The grinding and deburring of the honeycomb seal that are required by the prior art are eliminated. In addition, the honeycomb seals of the invention are distinguished by a lower weight. This is particularly advantageous for aircraft engines. As a whole, the honeycomb seal in accordance with the invention can be manufactured in a more favorable manner. Also possible are higher manufacturing penetration and therefore value added.

Furthermore, it is possible for the honeycomb seals 10, 15, 20 to be manufactured from another material than the supporting structures 11, 19 or 23. Thus, the supporting structures can be manufactured from ceramics for example. In the case of the supporting structures 11, 19 or 23, these are components that are used in aircraft engines in the housing of the engines. The honeycomb seals 10, 15, 20 or segments of the honeycomb seals can then be inserted in a simple manner into the supporting structures 11, 19 or 23 that are fastened in the housing of the engine.

The honeycomb seals 10, 15 and 20 can also be manufactured as a single piece with the supporting structures 11, 19 or 23 using MIM technology, i.e., using powder metallurgical injection molding, wherein this integral part can be arranged directly in the housing.

Because of the low costs and the simple manufacturing, the honeycomb seals 10, 15 and 20 can be used as disposable parts.

The precision of the MIM method to manufacture the honeycomb seal is so high that even the finest structures can be embodied, such as the honeycomb elements 13, 17, 22, the tongue that cooperates with the slot or even part numbers.

1-14. (canceled)

15. A honeycomb seal, in particular to seal a radial gap between a rotor and a stator of a gas turbine, wherein the honeycomb seal is manufactured by powder metallurgical injection molding.

16. The honeycomb seal according to claim 15, wherein the honeycomb seal is composed of several segments and wherein the segments are embodied as a single piece and include a base element and honeycomb elements, and further wherein the base element bears the honeycomb elements.

17. The honeycomb seal according to claim 16, wherein the segments are manufactured by powder metallurgical injection molding.

18. The honeycomb seal according to claim 16, wherein the segments are connectable to a supporting structure and wherein the segments and the supporting structure are manufactured of different materials.

19. The honeycomb seal according to claim 18, wherein the base element of the segments include at least one guide section, wherein the segments are connectable to the supporting structure via the guide section, and wherein adjacent segments are interlocked with each other by a projection of a first segment engaging with a corresponding recess of a second segment.

20. A honeycomb seal, in particular to seal a radial gap between a rotor and stator of a gas turbine, wherein the honeycomb seal has a base element and honeycomb elements that are embodied as a single piece with the base element.

21. The honeycomb seal according to claim 20, wherein the honeycomb seal is composed of several segments, wherein each segment has a base element and honeycomb elements that are embodied as a single piece with the base element.

22. The honeycomb seal according to claim 21, wherein the base element of each segment includes at least one guide section and wherein each segment is connectable to a supporting structure via the guide section.

23. The honeycomb seal according to claim 21, wherein a first end of the segments includes a projection and a second end of the segments includes a recess and wherein the projection of a first segment is received within the recess of an adjacent segment.

24. The honeycomb seal according to claim 22, wherein the segments of the honeycomb seal and the supporting structure are manufactured of different materials.

25. The honeycomb seal according to claim 20, wherein the honeycomb seal is manufactured by powder metallurgical injection molding.

26. The honeycomb seal according to claim 22, wherein the honeycomb seal and the supporting structure are manufactured as a single piece.

27. The honeycomb seal according to claim 18, wherein the honeycomb seal and the supporting structure are manufactured as a single piece.

28. The honeycomb seal according to claim 15, wherein the radial gap sealed by the honeycomb seal lies between a rotating moving blade of the rotor and a housing of the stator or between a non-rotating guide blade of the stator and the rotor.

29. The honeycomb seal according to claim 20, wherein the radial gap sealed by the honeycomb seal lies between a rotating moving blade of the rotor and a housing of the stator or between a non-rotating guide blade of the stator and the rotor.

30. The honeycomb seal according to claim 16, wherein the honeycomb elements and the base element are composed of different materials.

31. The honeycomb seal according to claim 20, wherein the honeycomb elements and the base element are composed of different materials.

32. A method for manufacturing a honeycomb seal for sealing a radial gap between a rotor and a stator of a gas turbine, comprising the step of manufacturing the honeycomb seal by powder metallurgical injection molding.

33. The method of claim 32, further comprising the steps of:
subjecting a molded honeycomb seal to a releasing process to release a binding agent used in the powder metallurgical injection molding process; and
compressing the molded honeycomb seal after the releasing process via a sintering process.

34. The method of claim 32, further comprising the steps of forming the honeycomb seal in a plurality of segments wherein each segment is formed as a single piece that includes a base element and honeycomb elements and further wherein the base element bears the honeycomb elements.

35. The method of claim 34, further comprising the steps of connecting the plurality of segments to a supporting structure and manufacturing the plurality of segments and the supporting structure of different materials.

36. The method of claim 35, further comprising the steps of connecting a guide section of the base element to the supporting structure and interlocking adjacent segments with each other by engaging a projection of a first segment with a recess of an adjacent second segment.

37. A method of forming a honeycomb seal, in particular to seal a radial gap between a rotor and stator of a gas turbine, comprising the step of forming a base element of the honeycomb seal with honeycomb elements of the seal as a single piece.

38. The method of claim 37, further comprising the steps of:
forming the base element in a first material; and
forming the honeycomb elements in a second material.

39. The method of claim 37, further comprising the steps of:
forming the honeycomb seal in a plurality of segments, wherein each segment includes a base element and honeycomb elements;
forming a first segment of the plurality of segments in a first material; and
forming a second segment of the plurality of segments in a second material.

40. The method of claim 37, further comprising the steps of:
forming the honeycomb seal in a plurality of segments, wherein each segment includes a base element and honeycomb elements;
forming a first segment of the plurality of segments in a first physical geometry; and
forming a second segment of the plurality of segments in a second physical geometry.
